(19) United States
(12) Patent Application Publication
(10) Pub. No.: US 2026/0213784 A1
(43) Pub. Date: Jul. 23, 2026

(54) HYBRID CIRCUIT WITH HIGH LINEARITY FOR SINGLE-ENDED AND BI-DIRECTIONAL TRANSCEIVER AND EXTRACTING METHOD OF INBOUND SIGNAL THEREOF

(71) Applicant: NATIONAL CHENG KUNG UNIVERSITY, Tainan City (TW)

(72) Inventors: Ming-Yan FAN, Tainan City (TW); Yao-Chia LIU, Hsinchu City (TW); Ming-Xun WANG, Chiayi City (TW)

(21) Appl. No.: 19/182,888

(22) Filed: Apr. 18, 2025

(30) Foreign Application Priority Data
Jan. 21, 2025 (TW) 114102429

(51) Int. Cl. H04B 3/03; G05F 1/575; H04B 3/14; H04B 3/16

(52) U.S. Cl. CPC H04B 3/03; G05F 1/575; H04B 3/14; H04B 3/16

(57) ABSTRACT

A hybrid circuit with high linearity for single-ended and bi-directional transceiver and an extracting method of inbound signal thereof are disclosed. The hybrid circuit employs an isolation resistor to be connected to a single-ended transmission path in serial and a first hybrid signal and a second hybrid signal are generated at two ends of the isolation resistor. A voltage division ratio adjustment circuit adjusts two voltage swings of the first and second hybrid signals and then outputs a third and fourth hybrid signals with the same phase but different voltage swings to a comparison circuit. The comparison circuit directly compares the third and fourth hybrid signals and then outputs a voltage signal matching an inbound signal of a hybrid signal. Therefore, an adder or a subtractor consisted of a plurality of active components is not employed by the hybrid circuit and a linearity thereof is greatly increased.

### CROSS-REFERENCE TO RELATED APPLICATIONS

This application is based upon and claims priority under 35 U.S.C. 119 from Taiwan Patent Application No. 114102429 filed on Jan. 21, 2025, which is hereby specifically incorporated herein by this reference thereto.

### BACKGROUND OF THE INVENTION

### 1. Field of the Invention

The present invention is related to a single-ended and bi-directional transceiver, and more particularly to a hybrid circuit with high linearity for single-ended and bi-directional transceiver.

### 2. Description of the Prior Arts

Artificial Intelligence (hereinafter AI) related device or equipment use semiconductor components packaged with Chiplets, which integrate small chips with different functions on a single substrate through advanced packaging technology. The chips communicate with each other via the shortest transmission path (Short-Reach Die-to-Die Interfaces in 5-nm CMOS).

The input and output (I/O) circuits of general chips use a differential circuit architecture for a dual-ended and bi-directional transmission. With the development of AI applications, a single-ended and bi-directional transmission is adopted, and a transmission speed for the single-ended and bi-directional transmission is required to be the same as that for the dual-ended and bi-directional transmission. However, an outbound signal transmitted in the single-ended and bi-directional transmission is not easily eliminated since the single-ended and bi-directional transmission does not use the differential circuit architecture. Further, the I/O circuit without differential circuit architecture has signal delay and load difference, etc., issues caused by the RC circuit of a transceiver for the I/O circuit. Especially in asynchronous hybrid transmission applications, misjudging the high and low voltage levels of the inbound signal by the I/O circuit signal delay and load difference, etc., issues are more obvious.

With reference to FIG. 5, two single-ended and bi-directional transceivers 50 connected to a single transmission channel 40 are shown. The single transmission channel 40 has two opposite ends, each of which is connected to the corresponding single-ended and bi-directional transceiver 50. The single transmission channel 40 is used to transmit a hybrid signal mixed with an outbound signal (Data_{A}) and an inbound signal (Data_{B}) existing in single transmission channel 40 at the same time. Each transceiver 50 has a transmitter 51, a hybrid circuit 52 and a receiver 53. The hybrid circuit 52 is connected between the transmitter 51 and receiver 53 and extracts the inbound signal (Data_{B}) from the hybrid signal.

With reference to FIG. 6, a circuit diagram of the single-ended and bi-directional transceiver shown in FIG. 5 is illustrated. The hybrid circuit 52 mainly has an inverted replica driver 521 and an adder. The adder is consisted of three resistors R_{S}, Rₕ₁, Rₕ₂. With further reference to FIG. 7, the inverted replica driver 521 replicates the outbound signal (Data_{A}) of the transmitter 51 at the same time, inverts the replicated outbound signal (Vₙ) and then outputs the inverted outbound signal (Vₙ) to the adder. The adder is connected to the single transmission channel 40 to receive the hybrid signal (V_{PAD}) from the single transmission channel 40. Therefore, the inverted outbound signal and the hybrid signal are added by the adder and the outbound signal (Data_{A}) of the hybrid signal is eliminated to obtain the inbound signal (Data_{B}). The inbound signal (Data_{B}) is output to the receiver 53 and the receiver 53 generates a receiving signal (D_{bRX}) matching the inbound signal (Data_{B}). However, the hybrid circuit 52 of the transceiver 50 has to use the inverted replica driver 521, and a load difference at inputs of the hybrid circuit 52 makes that the inverted outbound signal (Vₙ) and the hybrid signal cannot input to the adder synchronously. Therefore, the high and low voltage levels of the incoming signal will be misjudged if the transceiver 50 of FIG. 6 is used in an asynchronous mixed transmission application. In addition, when a channel resistance of the single transmission channel 40 is ignored, a voltage swing of the receiving signal is only about 0.2×VDD.

With reference to FIGS. 8A and 8B, another transceiver 60 is shown and a hybrid circuit 62 thereof does not use the inverted replica driver. An isolation resistor (r) is connected between the output terminal of a transmitter 61 of the transceiver 60 and one end of the dual transmission channels 40a in serial to generate two almost synchronous hybrid signals V_{S}, V. The two hybrid signals V_{S}, V are further converted to a positive current signal and a negative current signal through a positive transconductance (hereinafter GM) circuit 622 and a negative GM circuit 621. Two positive and negative current signals are mixed to remove the same outbound signals V_{TX} of the two hybrid signals V_{S}, V and the rest of the current signal is converted to a voltage signal V_{RX} through resistors R_{gm1}, R_{gm2} corresponding to the inbound signal. Therefore, the hybrid circuit 60 does not have the load difference at inputs thereof like the hybrid circuit 52 in FIG. 6 has. As shown in FIG. 8B, the negative GM circuit 621 may be a differential circuit so the transceiver 60 is only used in the dual transmission channel 40a. Since the positive and negative GM circuits 622, 621 are consisted of PMOS devices, they have nonlinear conversion characteristics. When the two hybrid signals V_{S}, V are respectively input to the positive and negative GM circuits 622, 621, the conversion of the voltage signal to the current signal is limited by the nonlinear conversion characteristics of the PMOS element, and the outbound signal cannot be eliminated entirely from the hybrid signal to obtain the receiving signal that matches the inbound signal correctly. In addition, when the positive and negative GM circuits 622, 621 are implemented in the semiconductor process, a mismatch issue occurs. The mismatch issue is one of the reasons why the outbound signals cannot be eliminated entirely from the hybrid signals. Therefore, if the transceiver 60 is used in an asynchronous mixed transmission application, the high and low voltage levels of the incoming signal will be misjudged.

Based on the foregoing description, in the conventional hybrid circuit of the transceiver for the single-ended and bi-directional transmission, the inverted replica driver and the adder are used to eliminate the outbound signal from the hybrid signal, but the signal delay and load difference occur to eliminate incompletely the outbound signal therefrom. Using the isolation resistor and the positive and negative GM circuits in another conventional hybrid circuit does not have load difference, but cannot be used in the transceiver for the single-ended and bi-directional transmission.

To overcome the shortcomings, the present invention provides a hybrid circuit with high linearity for single-ended and bi-directional transceiver and an extracting method of inbound signal thereof to mitigate or to obviate the aforementioned problems.

### SUMMARY

The objective of the present invention provides a hybrid circuit with high linearity for single-ended and bi-directional transceiver and an extracting method of inbound signal thereof.

To achieve the foregoing objective, the hybrid circuit with high linearity for single-ended and bi-directional transceiver has:
an isolation resistor adapted to be connected to the single-ended transmission path in serial and having a first end and a second end, wherein a first hybrid signal is generated at the first end and a second hybrid signal is generated at the second end, and the first and second hybrid signals are in-phase;
a voltage dividing ratio adjustment circuit connected to the first and second ends of the isolation resistor to receive the first and second hybrid signals and adjust two voltage swings of the first and second hybrid signals by different voltage dividing ratios and to output a third and fourth hybrid signals with the same phase but different voltage swings; and
a comparison circuit connected to the voltage dividing ratio adjustment circuit to receive and directly compare the third and fourth hybrid signals to output a voltage signal.

In the hybrid circuit with high linearity for single-ended and bi-directional transceiver of the present invention, the isolation resistor is directly connected to the single-ended transmission path in serial to generate the first and second hybrid signals with the same phase. The voltage dividing ratio adjustment circuit adjusts the voltage swings of the first and second hybrid signals by different voltage dividing ratios and then outputs the third and fourth hybrid signals with the same phase but different voltage swings. Therefore, the comparison circuit directly compares the third and fourth hybrid signals to generate the voltage signal. The voltage signal matches an inbound signal of the hybrid signal. Thus, the present invention does not require an inverted replica driver, an adder or a positive and negative GM circuits, so an integrated circuit layout area of the present invention is relatively reduced. In addition, the hybrid circuit of the present invention also solves the problem that the conventional hybrid circuit uses active components, such as PMOS devices, to add and subtract signals, which is affected by the nonlinear conversion characteristics of active components and leads to poor linear performance. That is, the hybrid circuit of the present invention has a better linearity and correctly extracts the inbound signal in time if used in asynchronous mixed transmission application.

To achieve the foregoing objective, the extracting method of an inbound signal of the hybrid circuit with high linearity for a single-ended and bi-directional transceiver has steps of:
(a) obtaining a first and second hybrid signals with the same phase from a single-ended transmission path on which a hybrid signal is transmitted, wherein the hybrid signal is a mixture of an outbound signal and an inbound signal;
(b) adjusting two voltage swings of the first and second hybrid signals to generate a third and fourth hybrid signals with the same phase, wherein a voltage swing of the third hybrid signal is larger than that of the fourth hybrid signal; and
(c) comparing the third and fourth hybrid signals to generate a voltage signal matching the inbound signal.

In the extracting method of the inbound signal of the hybrid circuit with high linearity for a single-ended and bi-directional transceiver of the present invention, the first and second hybrid signals are directly obtained from the single-ended transmission path on which the hybrid signal is transmitted. The voltage swings of the first and second hybrid signals are further adjusted to the third and fourth hybrid signals with the same phase but different voltage swings. The third and fourth hybrid signals are directly compared to generate the voltage signal, which matches the inbound signal of the hybrid signal. Therefore, the present invention does not extract the inbound signal by eliminating the outbound signal from the hybrid signal, so the present invention does not use an outbound signal generating circuit (such as an inverted replica driver or negative GM circuit) composed of active components. Therefore, the present invention can correctly extract the inbound signal from the single transmission channel.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a hybrid circuit with high linearity for single-ended and bi-directional transceiver of a first embodiment in accordance with the present invention;

FIG. 2 is a circuit diagram of a hybrid circuit with high linearity for single-ended and bi-directional transceiver of a second embodiment in accordance with the present invention;

FIG. 3A is a circuit diagram of a hybrid circuit with high linearity for single-ended and bi-directional transceiver of a third embodiment in accordance with the present invention;

FIG. 3B is a circuit diagram of a hybrid circuit with high linearity for single-ended and bi-directional transceiver of a fourth embodiment in accordance with the present invention;

FIGS. 4A to 4E are voltage waveform diagrams of the hybrid circuit with high linearity for single-ended and bi-directional transceiver in accordance with the present invention;

FIG. 5 is a block diagram of two conventional single-ended and bi-directional transceivers connected to a single transmission channel in accordance with the prior art;

FIG. 6 is a circuit diagram of a conventional single-ended and bi-directional transceiver connected to a single transmission channel in accordance with the prior art;

FIG. 7 is a voltage waveform diagram of FIG. 6;

FIG. 8A is a circuit block diagram of a conventional transceiver for dual-ended and bi-directional transmission in accordance with the prior art; and

FIG. 8B is a partial detailed circuit diagram of FIG. 8A.

### DETAILED DESCRIPTION OF THE EMBODIMENTS

The present invention relates to a hybrid circuit with high linearity for a single-ended bidirectional transmission circuit. The present invention is described in detail below with reference to a plurality of embodiments and accompanying drawings.

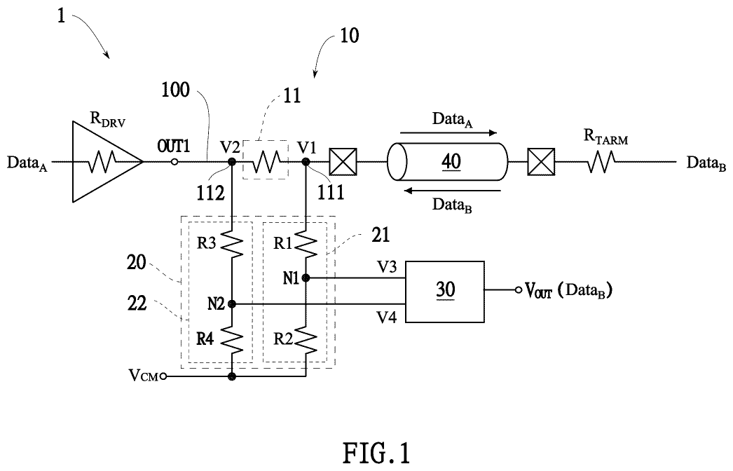

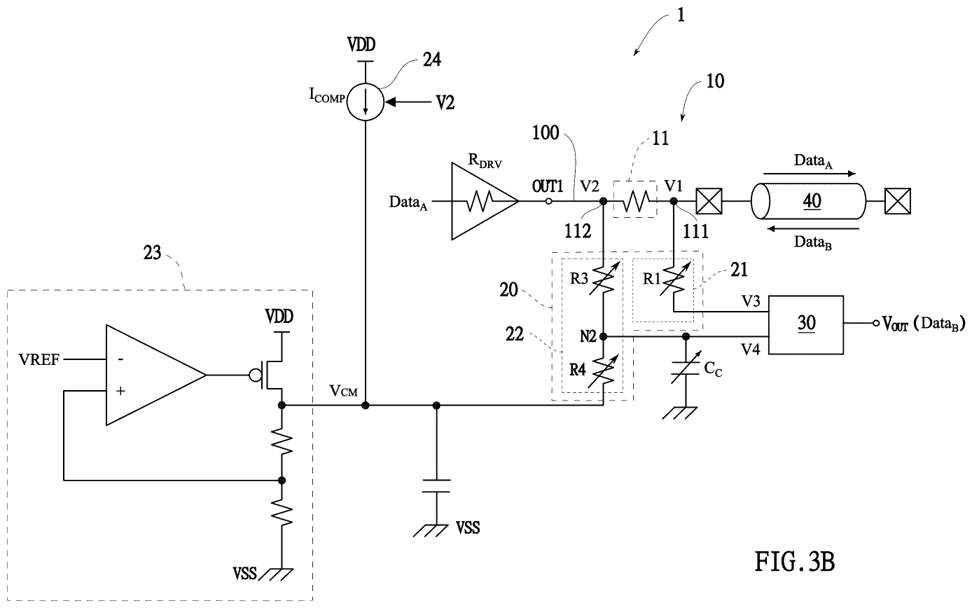

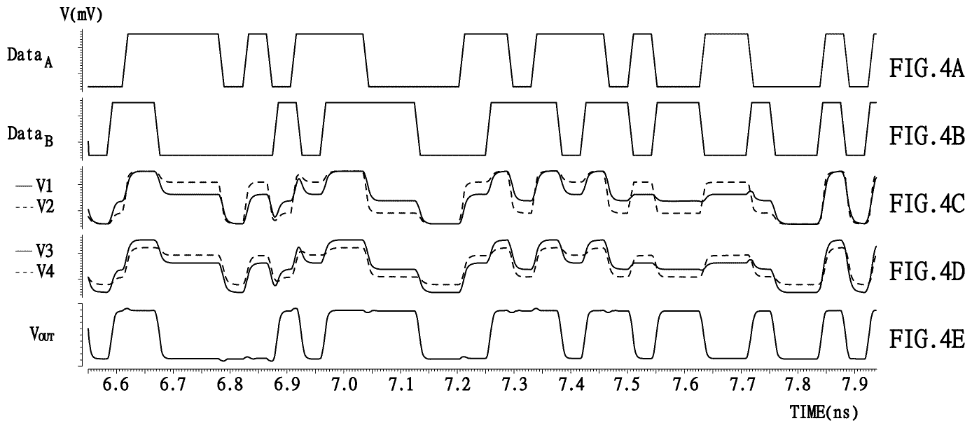

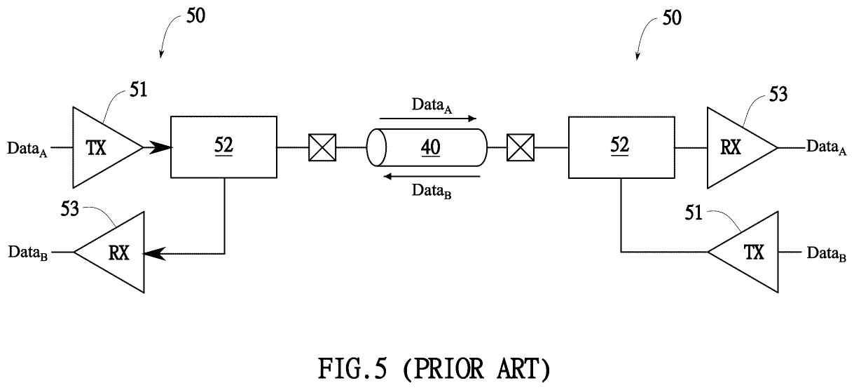

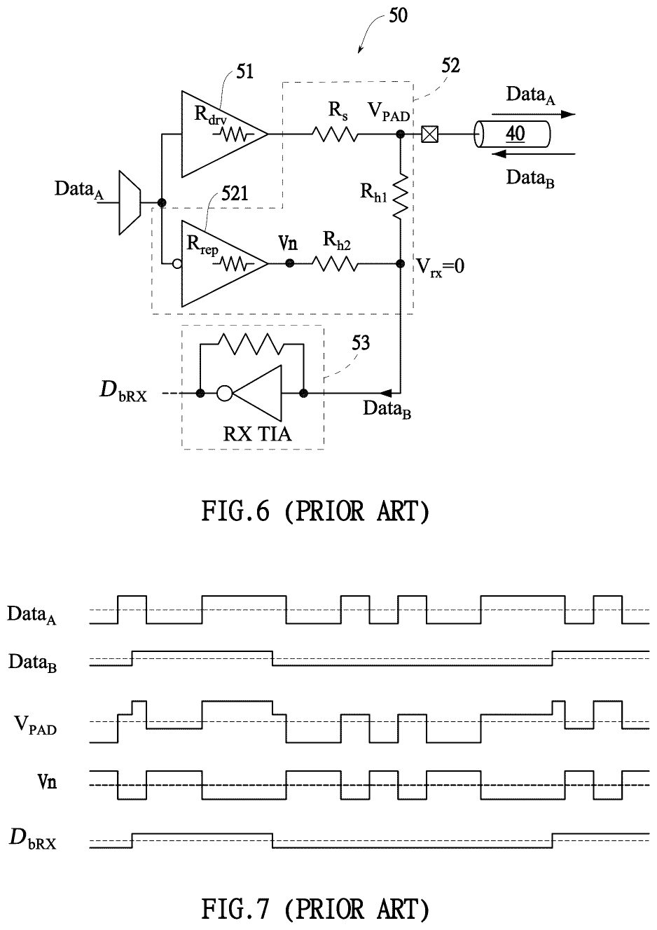

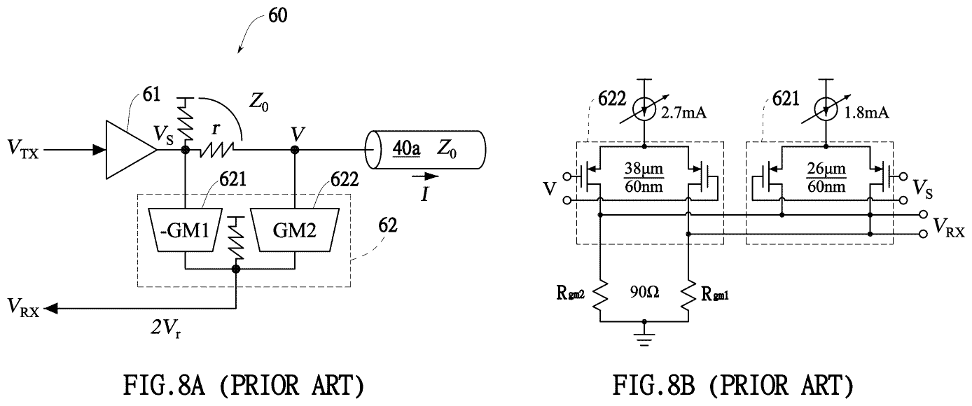

With reference to FIGS. 1, 4A and 4B, a first embodiment of the hybrid circuit 10 with high linearity for the single-ended bidirectional transmission circuit 1 is shown. The single-ended bidirectional transmission circuit 1 has a single signal terminal (OUT1) used to connect to a single transmission channel 40. A single-ended transmission path 100 is consisted of the single signal terminal (OUT1) and the single transmission channel 40. Since the single-ended transmission path 100 provides a bi-directional transmission, an outbound signal (Data_{A}) and an inbound signal (Data_{B}) are mixed to a hybrid signal transmitted on the single ended transmission path 100. The hybrid circuit 10 is connected to the single ended transmission path 100 in serial to correctly extract the inbound signal (Data_{B}) from the hybrid signal. The hybrid circuit 10 has an isolation resistor 11, a voltage dividing ratio adjustment circuit 20 and a comparison circuit 30.

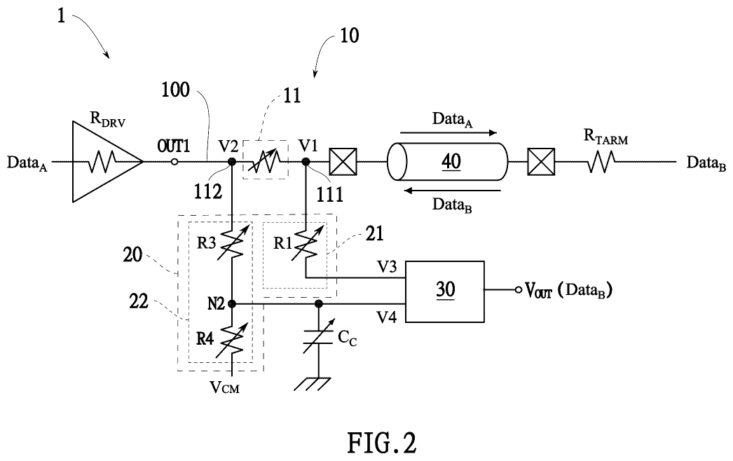

The isolation resistor 11 is connected to the single ended transmission path 100 in serial. Since the hybrid signal is transmitted on the single ended transmission path 100, as shown in FIG. 4C, a first end 111 and a second end 112 of the isolation resistor 11 respectively generate a first hybrid signal V1 and a second hybrid signal V2. The first and second hybrid signals V1, V2 have the same phase. That is, the phases of the first and second hybrid signals V1, V2 are substantially equal to that of the hybrid signal. In the present embodiment, the isolation resistor 11 may be about 25 ohms, but in another embodiment, an isolation resistor 11 with higher resistance may be used to increase a voltage swing of the second hybrid signal V2. With further reference to FIG. 2, in a second embodiment, an isolation resistor 11 of the hybrid circuit 10 may be a variable resistor to fine-tune a resistance of the isolation resistor 11.

The voltage dividing ratio adjustment circuit 20 is connected to the first and second ends 111, 112 of the isolation resistor 11 to receive the first and second hybrid signals V1, V2. The voltage dividing ratio adjustment circuit 20 adjusts two voltage swings of the first and second hybrid signals V1, V2 and then outputs a third hybrid signal V3 and a fourth hybrid signal V4. As shown in FIG. 4D, the third and fourth hybrid signals V3, V4 have the same phase but have different voltage swings. In the present embodiment, the voltage dividing ratio adjustment circuit 20 has a first voltage dividing circuit 21 and a second voltage dividing circuit 22. The first voltage dividing circuit 21 has a first resistor R1 and a second resistor R2 connected in serial. The second voltage dividing circuit 22 has a third resistor R3 and a fourth resistor R4 connected in serial. A first dividing ratio of the first voltage dividing circuit 21 is determined by the first and second resistors R1, R2, and a second dividing ratio of the second voltage dividing circuit 22 is determined by the third and fourth resistors R3, R4 but is different from the first dividing ratio. Since the first and second voltage dividing ratios are different, the voltage swings of the first and second hybrid signals V1 and V2 are respectively divided by the first and second voltage dividing ratios to generate the third and fourth hybrid signals V3, V4 with different voltage swings. In the present embodiment, the first voltage dividing ratio is greater than the second voltage dividing ratio, so the voltage swing of the third hybrid signal V3 is larger than that of the fourth hybrid signal V4.

In one embodiment, a resistance of the second resistor R2 of the first voltage dividing circuit 21 may almost be infinity, so the first voltage dividing ratio is substantially close to one. As shown in FIG. 2, the second resistor R2 is substantially open. That is, the hybrid circuit 10 of FIG. 2 does not require the second resistor R2 in the first embodiment as shown in FIG. 1, the third hybrid signal V3 is substantially equal to the first hybrid signal V1, and the second voltage dividing circuit 22 shrinks the voltage swing of the second hybrid signal V2. In addition, in the present embodiment, the first to fourth resistors R1 to R4 may be fixed resistors, but in the second embodiment of FIG. 2, the first resistor R1, the third resistor R3 and the fourth resistor R4 may be variable resistors to adapt to different signal environments of the single-ended bidirectional transmission circuits. For instance, if the resistance R_{CH} of the single transmission channel 40 is further considered, the resistances of the first resistor R1, the third resistor R3 and the fourth resistor R4 should be fine-tuned according to the resistance R_{CH} of the single transmission channel 40 to optimize the third and fourth hybrid signals V3, V4. Again, since an RC constant of the second voltage dividing circuit 22 is less than that of the first voltage dividing circuit 21, the third hybrid signal V3 and the fourth hybrid signal V4 arrive at the comparison circuit 30 at different times. As shown in FIG. 2, a voltage dividing node N2 of the second voltage dividing circuit 22 is connected to a ground capacitor C_{C} to increase the RC constant of the second voltage dividing circuit 22. Therefore, a time difference between the third hybrid signal V3 and the fourth hybrid signal V4 arriving at the comparison circuit 30 is shortened. In addition, the ground capacitor C_{C} may be a fixed capacitor or a variable capacitor.

The comparison circuit 30 is connected to the voltage dividing ratio adjustment circuit 20 to receive the third and fourth hybrid signals V3, V4 and then directly compares the third and fourth hybrid signals V3, V4 to output a voltage signal V_{OUT}. The voltage signal V_{OUT} matches the inbound signal (Data_{B}) of the hybrid signal transmitted on the single-ended transmission path 100. With reference to FIGS. 4A, 4B and 4E, the outbound signal (Data_{A}) is eliminated from the hybrid signal and the voltage signal V_{OUT} matches the inbound signal (Data_{B}), so the comparison circuit 30 correctly extracts the inbound signal (Data_{B}) from the hybrid signal. With reference to FIGS. 4D and 4E, since the third and fourth hybrid signals have the same phase but have different voltage swings, a plurality of time points when the two voltage waveforms intersect are a rising time or a falling time of the inbound signal (Data_{B}) as shown in FIG. 4B. In the present embodiment, the voltage swing of the third hybrid signal V3 is greater than that of the fourth hybrid signal V4, when the comparison circuit 30 compares the third hybrid signal V3 with a higher voltage level to the fourth hybrid signal V4 with a lower voltage level at the same time, the comparison circuit 30 outputs the voltage signal V_{OUT} with a high voltage level. On the contrary, when the comparison circuit 30 compares the third hybrid signal V3 with a lower voltage level to the fourth hybrid signal V4 with a higher voltage level at the same time, the comparison circuit 30 outputs the voltage signal V_{OUT} with a low voltage level. Therefore, with reference to FIGS. 4B and 4E, the voltage signal V_{OUT} correctly matches the inbound signal (Data_{B}). In another embodiment, the comparison circuit 30 may use a rail-to-rail comparator, but not limited to.

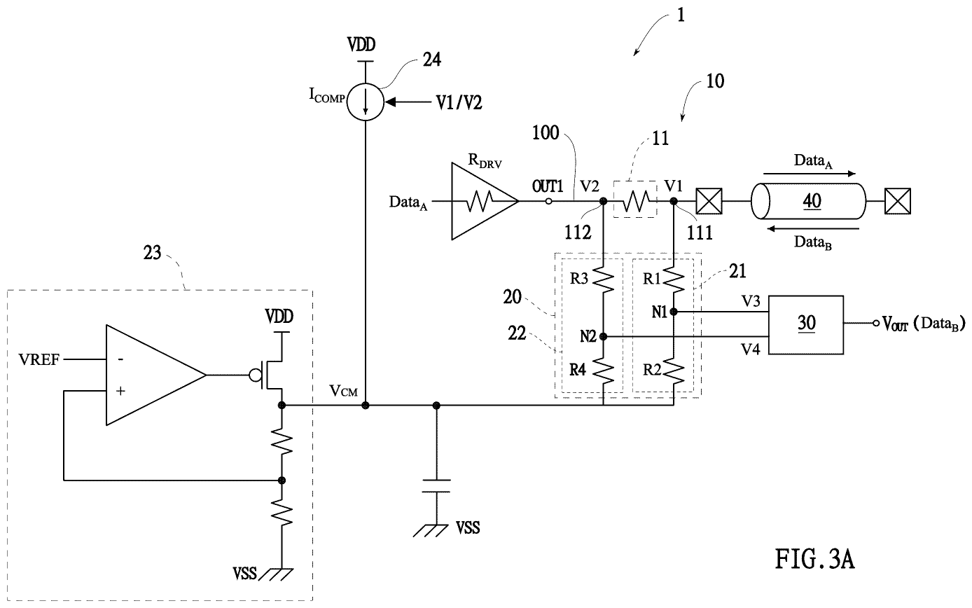

With reference to FIG. 3A, a third embodiment of a hybrid circuit 10 with high linearity for a single-ended and bi-directional transceiver 1 of the present invention is shown. The third embodiment is similar to the first embodiment of FIG. 1, but a common mode voltage generator 23 is added. The common mode voltage generator 23 is a low-dropout regulator (hereinafter LDO). A common mode voltage terminal V_{CM} of the LDO is connected to the second resistor R2 of the first voltage dividing circuit 21 and the fourth resistor R4 of the second voltage dividing circuit 22. That is, one end of the second resistor R2 and the one end of the fourth resistor R4 are commonly connected to the common mode voltage terminal V_{CM}. However, the common mode voltage is unstable as the voltage levels of the first and second hybrid signals V1, V2 change. During the voltage levels of the first and second hybrid signals V1, V2 are increasing, the first and second hybrid signals V1, V2 generate source currents to the common mode voltage. On the contrary, the voltage levels of the first and second hybrid signals V1, V2 are decreasing, the first and second hybrid signals V1, V2 generate draw currents to the common mode voltage. Therefore, a voltage-controlled current source 24 is connected between the first end 111 and the second end 112 of the isolation resistor 11 and the common mode voltage terminal V_{CM} of the LDO to stabilize the common mode voltage of the LDO. The voltage-controlled current source 24 outputs a compensation current to the common mode voltage terminal V_{CM} of the LDO as the voltage levels of the first and second mixed signals V1 and V2 change, and the common-mode voltage is further stabilized.

With reference to FIG. 3B, a fourth embodiment of a hybrid circuit 10 with high linearity for single-ended and bi-directional transceiver 1 of the present invention is shown. The fourth embodiment is similar to the second embodiment of FIG. 2, but a common mode voltage generator 23 and a voltage-controlled current source 24 are added. A common mode voltage terminal V_{CM} of the common mode voltage generator 23 is connected to the fourth resistor R4 of the second voltage dividing circuit 22 to provide a common mode voltage to the second voltage dividing circuit 22. The voltage-controlled current source 24 is connected to the second end 112 of the isolation resistor 11 and the common mode voltage terminal V_{CM} of the common mode voltage generator 23. The voltage-controlled current source 24 outputs t a compensation current to the common mode voltage terminal V_{CM} as the voltage level of the second mixed signal V2 changes to stabilize the common-mode voltage.

Based on the foregoing description, an extracting method of the inbound signal for single-ended and bi-directional transceiver 1 has steps of (a) to (c).

In the step (a), as shown in FIG. 1, the first hybrid signal V1 and the second hybrid signal V2 with the same phase are obtained from the single-ended transmission path 100 on which a hybrid signal is transmitted. The phases of the first and second hybrid signal V1 and V2 are substantially equal to the phase of the hybrid signal. The hybrid signal is a mixture of an outbound signal (Data_{A}) and an inbound signal (Data_{B}), as shown in FIGS. 4A and 4B. In one embodiment, the step (a) uses an isolation resistor 11, which is connected to the single-ended transmission path 100 in serial and the first and second hybrid signals V1, V2 with the same phase are respectively generated at two ends 111, 112 of the isolation resistor 11.

In the step (b), as shown in FIGS. 4C and 4D, two voltage swings of the first and second hybrid signals V1, V2 are adjusted to generate a third and fourth hybrid signals V3, V4 with the same phase but different voltage swings. In one embodiment, the voltage swing of the third hybrid signal V3 is larger than that of the fourth hybrid signal V4. According to the voltage dividing ratio adjustment circuit 20 as mentioned above, the first and second voltage dividing circuits 21, 22 adjust the voltage swings of the first and the second hybrid signals V1, V2 according to the first and second voltage dividing ratios. And then, the third hybrid signal V3 is generated at a first voltage dividing node N1 and the fourth hybrid signal V4 is generated at the second voltage dividing node N2. The voltage swing of the third hybrid signal V3 is larger than that of the fourth hybrid signal V4. As shown in FIG. 2, a first voltage dividing ratio of the first voltage dividing circuit 21 may be substantially close to one and as shown in FIGS. 4C and 4D, a third hybrid signal V3 is substantially equal to the first hybrid signal V1.

In the step (c), the third and fourth hybrid signals V3, V4 are directly compared to generate a voltage signal V_{OUT} and the voltage signal V_{OUT} matches the inbound signal (Data_{B}).

Based on the foregoing description, the hybrid circuit with high linearity for single-ended and bi-directional transceiver of the present invention uses the isolation resistor to directly connect to the single-ended transmission path in serial and the first and second hybrid signals with the same phase are generated at two ends of the isolation resistor. The voltage dividing ratio adjustment circuit further adjusts the voltage swings of the first and second hybrid signals by different voltage dividing ratios and then outputs the third and fourth hybrid signals with the same phase but different voltage swings. Therefore, the comparison circuit directly compares the third and fourth hybrid signals to generate the voltage signal. The voltage signal matches the inbound signal of the hybrid signal. Thus, the present invention does not require an inverted replica driver, an adder or a positive and negative GM circuits, so an integrated circuit layout area of the present invention is relatively reduced. In addition, the hybrid circuit of the present invention also solves the problem that the conventional hybrid circuit uses active components, such as PMOS devices, to add and subtract signals, which is affected by the nonlinear conversion characteristics of active components and leads to poor linear performance. That is, the hybrid circuit of the present invention has a better linearity and correctly extracts the inbound signal in time if used in asynchronous mixed transmission application.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hybrid circuit with high linearity for single-ended and bi-directional transceiver, wherein the single-ended and bi-directional transceiver has a single signal terminal connected to a single transmission channel to constitute a single-ended transmission path, on which a hybrid signal mixed by an outbound signal and an inbound signal is transmitted, comprising:
an isolation resistor adapted to be connected to the single-ended transmission path in serial and having a first end and a second end, wherein a first hybrid signal is generated at the first end and a second hybrid signal is generated at the second end, and the first and second hybrid signals are in-phase;
a voltage dividing ratio adjustment circuit connected to the first and second ends of the isolation resistor to receive the first and second hybrid signals and adjust two voltage swings of the first and second hybrid signals by different voltage dividing ratios and to output a third and fourth hybrid signals with the same phase but different voltage swings; and
a comparison circuit connected to the voltage dividing ratio adjustment circuit to receive and directly compare the third and fourth hybrid signals to output a voltage signal.

2. The hybrid circuit with high linearity as claimed in claim 1, wherein the voltage dividing ratio adjustment circuit has:
a first voltage dividing circuit having a first resistor and a second resistor connected in serial to define a first voltage division ratio, wherein the first resistor is connected to the first end of the isolation resistor to receive the first hybrid signal and the first hybrid signal is divided into the third hybrid signal according to the first voltage division ratio; and
a second voltage divider circuit having a third resistor and a forth resistor connected in serial to define a second voltage division ratio, wherein the third resistor is connected to the second end of the isolation resistor to receive the second hybrid signal and the second hybrid signal is divided into the fourth hybrid signal according to the second voltage division ratio, wherein the second voltage division ratio is less than the first voltage division ratio.

3. The hybrid circuit with high linearity as claimed in claim 2, wherein the first voltage division ratio is substantially one and the second resistor is substantially open.

4. The hybrid circuit with high linearity as claimed in claim 2, wherein the comparison circuit is a rail-to-rail comparator.

5. The hybrid circuit with high linearity as claimed in claim 3, wherein the comparison circuit is a rail-to-rail comparator.

6. The hybrid circuit with high linearity as claimed in claim 2, wherein one end of the second resistor and one end of the fourth resistor are commonly connected to a common mode voltage terminal of a common mode voltage generator.

7. The hybrid circuit with high linearity as claimed in claim 3, wherein one end of the fourth resistor is connected to a common mode voltage terminal of a common mode voltage generator.

8. The hybrid circuit with high linearity as claimed in claim 6, wherein the common mode voltage generator is a low-dropout regulator.

9. The hybrid circuit with high linearity as claimed in claim 7, wherein the common mode voltage generator is a low-dropout regulator.

10. The hybrid circuit with high linearity as claimed in claim 8, wherein the first end and the second end of the isolation resistor are connected to the common mode voltage terminal of the low-dropout regulator through a voltage-controlled current source.

11. The hybrid circuit with high linearity as claimed in claim 9, wherein the second end of the isolation resistor is connected to the common mode voltage terminal of the low-dropout regulator through a voltage-controlled current source.

12. The hybrid circuit with high linearity as claimed in claim 2, wherein a voltage dividing node of the second voltage dividing circuit is connected to a ground capacitor.

13. The hybrid circuit with high linearity as claimed in claim 3, wherein a voltage dividing node of the second voltage dividing circuit is connected to a ground capacitor.

14. The hybrid circuit with high linearity as claimed in claim 2, wherein the first, second, third and fourth resistors are variable resistors.

15. The hybrid circuit with high linearity as claimed in claim 3, wherein the first, third and fourth resistors are variable resistors.

16. The hybrid circuit with high linearity as claimed in claim 12, wherein the ground capacitor is a variable capacitor.

17. An extracting method of an inbound signal of the hybrid circuit with high linearity for a single-ended and bi-directional transceiver, comprising steps of:
(a) obtaining a first and second hybrid signals with the same phase from a single-ended transmission path on which a hybrid signal is transmitted, wherein the hybrid signal is a mixture of an outbound signal and an inbound signal;
(b) adjusting two voltage swings of the first and second hybrid signals to generate a third and fourth hybrid signals with the same phase, wherein a voltage swing of the third hybrid signal is larger than that of the fourth hybrid signal; and
(c) comparing the third and fourth hybrid signals to generate a voltage signal matching the inbound signal.

18. The extracting method of an inbound signal of the hybrid circuit with high linearity as claimed in claim 17, wherein in the step (a), an isolation resistor is connected to the single-ended transmission path in serial and the first and second hybrid signals are respectively generated at two ends of the isolation resistor.

19. The extracting method of an inbound signal of the hybrid circuit with high linearity as claimed in claim 18, wherein in the step (b),
a first voltage dividing circuit adjusts the voltage swing of the first hybrid signal by a first division ratio to generate the third hybrid signal at a voltage dividing node of the first dividing circuit; and
a second voltage dividing circuit adjusts the voltage swing of the second hybrid signal by a second division ratio to generate the fourth hybrid signal at a voltage dividing node of the second dividing circuit, wherein the first voltage dividing ratio is greater than the second voltage dividing ratio.

20. The extracting method of an inbound signal of the hybrid circuit with high linearity as claimed in claim 19, wherein in the step (b), the first voltage dividing ratio is substantially one and the third hybrid signal is substantially equal to the first hybrid signal.
